(19) United States
(12) Patent Application Publication
(10) Pub. No.: US 2003/0144891 A1
(43) Pub. Date: Jul. 31, 2003

(54) Supervising the processing status of activities within workflow management systems

(75) Inventors: Frank Leymann, Aidlingen (DE); Dieter Roller, Schoenaich (DE)

Correspondence Address: Gerald R. Woods,, IBM Corporatin T81/503, PO Box 12195, Research Triangle Park, NC, 27709, US

(73) Assignee: International Business Machines Corporation, Armonk, NY (US)

(21) Appl. No.: 10/349,676

(22) Filed: Jan. 23, 2003

(30) Foreign Application Priority Data
Jan. 26, 2002 (EP) 02001822.2

(51) Int. Cl. G06F 17/60

(52) U.S. Cl. 705/7

(57) ABSTRACT

In a method for supervising the processing status of activities of a business process managed by a Workflow-Management-Systems or a computer system with comparable functionality (WFMS), the activity is checked to determine whether the processing status of the activity instance has an in doubt status. If an in doubt status is found, a check is made to determine whether a dedicated check-activity is associated with the activity, a check-activity being capable of dynamically analyzing the processing status of its associated activity. If a dedicated check-activity is found, an instance is launched to determine the processing status of the activity instance.

### BACKGROUND OF THE INVENTION

1. Field of the Invention

The present invention relates to a technology for supervising the processing status of activities of business processes managed by a Workflow-Management-Systems (WFMS) or a computer system with WFMS functionality.

2. Background of the Invention

Workflow-Management-Systems (WFMS) support the definition and execution of business processes. Business processes executed within a WFMS environment control who will perform which piece of work of a network of pieces of work and which resources are used for this work. The individual pieces of work might be distributed across a multitude of different computer systems connected by some type of network. A thorough description of the technologies of WFMS has been given by F. Leymann, D. Roller, Production Workflow: Concepts and Techniques, Prentice Hall, 2000.

A WFMS implements a particular meta model for modeling business processes. The most prominent meta model is the graph-oriented process meta model, implemented for example by an IBM MQSeries Workflow product. It supports the modeling of business processes as a network of activities. This network of activities, the process model, is constructed as a directed, acyclic, weighted, colored graph. The nodes of the graph represent the activities that are performed. The edges of the graph, the control connectors, describe the potential sequence of execution of the activities. Definition of the process graph is achieved via IBM MQSeries Workflow's Flow Definition Language (FDL) or via a built-in graphical editor. The runtime component of the Workflow-Management-System uses the process model as a template to create process instances. Within a process instance the WFMS controls the execution sequence by navigating through that graph by providing and passing control to the individual activity instances.

Activity implementations may terminate abnormally due to a myriad of different hardware or software reasons. Where an abnormal termination occurs and the precise status of a certain activity is unclear, a fundamental difficulty is that existing technology does not allow a WFMS to exactly determine the processing status of any activity instance being controlled by that WFMS at a given point in time. The only teachings available within the state of the art are partial solutions only. Most of these solutions are able only to identify (more or less precisely) a certain problem situation and finally require the intervention of a human user to finally solve the problem. The known solutions assume specific characteristics of the activities and thus are not able to provide a complete solution to this problem applicable to all types of activities.

One approach to making sure that an activity implementation is executed correctly once is to execute the activity implementation as a transaction protected by an underlying transaction management system. Such an activity is called a safe application; that is, the activity is realized as a transaction controlled by a transaction management system typically external to the WFMS. Thus, according to this approach, the processing state of a certain activity is delegated by the WFMS to a transaction management system. The WFMS can then be sure that the activity either is executed successfully or is not executed at all. This is referred to as atomic behavior of transactions. It is pointed out that even with transaction management systems there exists a small probability that a safe application is not executed at all. Even with such an approach there still exists a small uncertainty about the processing state of an activity. A further consequence is that even with “safe applications” (according to above definition) the outcome of execution may be unknown in case of crashes of the underlying operating system for instance.

If the activity implementation is not carried out as a safe application, the actions taken by the WFMS in the case of failure depend on the mechanism that was used to invoke the activity implementation. If the WFMS recognizes the abnormal termination, the WFMS can put the activity into an InError state, typically associated with an appropriate error indicator. If the WFMS cannot recognize an abnormal termination, the activity stays in the running state. If a time-out value has been provided, the WFMS puts the activity into an inError state, when the specified time-out value has been exceeded. However, it is unclear in both situations whether the activity implementation has been completed or whether it has been performed only partially. Another possibility would be that the activity is being performed properly but that the allowed time-out value is just too short for the type of activity. If that occurs, the decision of the WFMS to put the activity into the InError state itself is erroneous.

Another prior art approach is based on so-called idemnipotent applications. Idemnipotent applications are implemented in a manner that allows them to be executed more than once while producing only a single set of results; in other words, any additional execution of an idemnipotent application after its first successful execution will have no further effect. Where the WFMS knows a certain activity is of idemnipotent nature, it can make use of that knowledge where the activity executes with a failure or wherein the WFMS is in doubt about the success of the activity. If the activity is carried out once more, WFMS may base a decision on the results of a prior execution. The disadvantage of this solution is that the activity implementation must implement that property, which is something that cannot be done in all cases due to technical reasons.

In yet another state-of-the-art approach it has been suggested that activities that have a “non-safe activity” implementation (according to above definition of save applications) be flagged when the workflow management system is restarted. This would allow a process administrator to check out the status of the activity and take appropriate actions. The disadvantage of this solution is that the process administrator must do this for every activity that is in the running state. Even worse, this is a time consuming approach requiring repeated user intervention.

If the WFMS (or the underlying operating system or any other component required by the WFMS) terminates abnormally, the WFMS is brought up again and continues operation. The transaction manager undoes all activity implementations that are carried out as transactions and restarts them automatically. Activity implementations that are not carried out as transactions are processed as usual. If, for example, the activity is in the running state and no time-out value is specified, the activity continues to stay in the running state. If a time-out value is specified, the activity eventually reaches an inError state. If no time-out value is specified, the activity will stay forever in the running state indefinitely.

As can be seen from the foregoing, current state of the art WFMS technology does not provide a systematic approach allowing a WFMS to exactly determine, at any particular point in time, the processing status of any activity instance within any business process being controlled by that WFMS.

### SUMMARY OF THE INVENTION

An object of the invention is to allow a WFMS to exactly determine at any given point in time the processing status of any activity instance within any business process being controlled by that WFMS.

The objective is achieved by a series of method steps, the first of which is to check whether the processing status of the activity-instance is in doubt. If doubt exists, a determination is made whether a dedicated check-activity is associated with the activity. A dedicated check-activity is capable of dynamically analyzing the processing status of its associated activity. If a dedicated check-activity is found, an instance of the check-activity is launched to determine the processing status of the activity-instance.

The most important advantage of the invention is that it allows a WFMS to exactly determine, at any point in time, the processing status of any activity instance being controlled by that WFMS. As the check activity is specifically tailored to its associated activity this analysis may be arbitrarily precise. Moreover, the invention provides a unified approach that is independent of the multitude of execution environments available for processing activities.

### BRIEF DESCRIPTION OF THE DRAWINGS

FIG. 1 shows a business process model represented by a process graph according to the state of the art.

FIG. 2 depicts the detailed structure of an activity within a WFMS.

FIG. 3 shows the relationships between an activity and its associated program implementations being executable under the control of various operating systems.

FIG. 4 visualizes a flow definition language (FDL) fragment illustrating how a certain activity is associated with corresponding activity implementations.

FIG. 5 illustrates, with the help of a pseudo-code example, how a WFMS can be enabled to supervise activity instances with respect to their processing states in accordance with the current invention.

FIG. 6 illustrates the definition construct, within an example of a process model, associating a so-called check activity implementation with a certain activity.

FIG. 7 is an alternate embodiment for associating a check activity implementation with an activity.

FIG. 8 illustrates on an exemplary level some of the states a process instance can take when it is carried out by the Workflow-Management-System.

### DESCRIPTION OF A PREFERRED EMBODIMENT

The drawings and specification set forth a preferred embodiment of the invention. Modifications and changes may be made in the preferred embodiment without departing from the spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein. The present invention can also be embedded in a computer program product, that comprises all the features enabling the implementation of the methods described herein, and that—when loaded in a computer system—is able to carry out these methods.

Computer program means or computer program in the present context means any expression, in any language, code or notation, of a set of instructions intended to cause a system having an information processing capability to perform a particular function either directly or after either or both of the following: a) conversion to another language, code or notation; b) reproduction in a different material form.

The current invention is illustrated based on the meta model that is implemented by IBM's “MQSeries Workflow” workflow management system; i.e. it is based on the graph oriented process model. The invention is not, of course, limited to that system but may be applied to any type of meta model and any other WFMS instead. Furthermore, the current teaching applies also to any other type of system that offers WFMS functionalities not as a separate WFMS but within some other type of system.

The following is a short outline on the basic concepts of a workflow management system based on IBM's “MQSeries Workflow” WFMS.

From an enterprise point of view the management of business processes is becoming increasingly important. A business processes (or process for short) controls which piece of work will be performed by whom and which resources are used for this work. Generally, a business process describes how an enterprise will achieve its business goals. A WFMS may support both the modeling of business processes and their execution.

Modeling of a business process as a syntactical unit in a way that is directly supported by a software system is extremely desirable. Moreover, the software system can also work as an interpreter basically getting such a model as input. The model, called a process model or workflow model, can then be instantiated and the individual sequence of work steps depending on the context of the instantiation of the model can be determined. Such a model of a business process can be perceived as a template for a class of similar processes performed within an enterprise; it is a schema describing all possible execution variants of a particular kind of business process. An instance of such a model and its interpretation represents an individual process, i.e. a concrete, context-dependent execution of a variant prescribed by the model. A WFMS facilitates the management of business processes. It provides a means to describe models of business processes (at build time) and it drives business processes based on an associated model (at runtime). The meta model of IBM's WFMS MQSeries Workflow, i.e. the syntactical elements provided for describing business process models, and the meaning and interpretation of these syntactical elements, is described next.

It should also be noted that process graphs are the typical way of representing business processes in all of these approaches. This gives rise to a first observation: if advanced WFMS modeling constructs within WFMS meta models can be defined by making use of standard process graphs only then it can be assumed that such advanced modeling construct maybe realized in almost any WFMS.

In MQSeries, business processes are modeled as direct, acyclic, colored, and weighted graphs. The nodes of the graph represent the activities that need to be carried out. The edges of the graph are control connectors that describe the potential sequence in which the activities are to be carried out. Thus a process model is a complete representation of a business process, comprising a process diagram and the settings that define the logic behind the components of the diagram. Significant components of an MQSeries Workflow process model, some of which are described in detail below, are:

a) Processes;

b) Activities;

c) Blocks;

d) Control Flows;

e) Connectors;

f) Data Containers

g) Data Structures

h) Conditions;

i) Programs; and

j) Staff.

Activities are the fundamental elements of the meta model. An activity represents a business action that is, from a certain perspective, a semantic entity of its own. A MQSeries Workflow process model consists of the following types of activities:

A program activity has a program assigned to perform it. The program is invoked when the activity is started. In a fully automated workflow, the program performs the activity without human intervention. Otherwise, the user must start the activity by selecting it from a runtime work list. Output from the program can be used in the exit condition for the program activity and for the transition conditions to other activities.

A process activity has a process assigned to perform it. The process is invoked when the activity is started. A process activity represents a way to reuse a set of activities that are common to different processes. Output from the process can be used in the exit condition for the process activity and for the transition conditions to other activities.

The flow of control, i.e. the control flow through a running process, determines the sequence in which activities are executed. The MQSeries Workflow workflow manager navigates a path through the process that is determined by the evaluation to TRUE of start conditions, exit conditions, and transition conditions.

Connectors link activities in a process model. Connectors are used to define the sequence of activities and the transmission of data between activities. Since activities might not be executed arbitrarily, they are bound together via control connectors. A control connector might be perceived as a directed edge between two activities; the activity at the connector's end point cannot start before the activity at the start point of the connector has finished successfully. Default connectors specify where control should flow when the transition condition of no other control connector leaving an activity evaluates to TRUE. Default connectors enable the workflow model to cope with exceptional events. Data connectors specify the flow of data in a workflow model. A data connector originates from an activity or a block and has an activity or a block as its target. One can specify that output data is to go to one target or to multiple targets. A target can have more than one incoming data connector.

Process definition includes modeling of activities, control connectors between the activities, input/output container, and data connectors. A process is represented as a directed acyclic graph with the activities as nodes and the control/data connectors as the edges of the graph. The graph is manipulated via a built-in graphic editor. The data containers are specified as named data structures. These data structures themselves are specified via the DataStructureDefinition facility. Program activities are implemented through programs. The programs are registered via the Program Definition facility.

Blocks contain the same constructs as processes; that is, activities, control connectors, etc. Blocks are, however, not named and have their own exit condition. If the exit condition is not met, the block is started again. The block thus implements a Do Until construct. Process activities are implemented as processes. These subprocesses are defined separately as regular, named processes with all usual properties. Process activities offer great flexibility for process definition. A process can be constructed through permanent refinement of activities into program and process activities (top-down), but can also be built from a set of existing processes (bottom-up).

All programs that implement program activities are defined via the Program Registration Facility. For each program, the Facility registers the name of the program, its location, and the invocation string. The invocation string consists of the program name and the command string passed to the program.

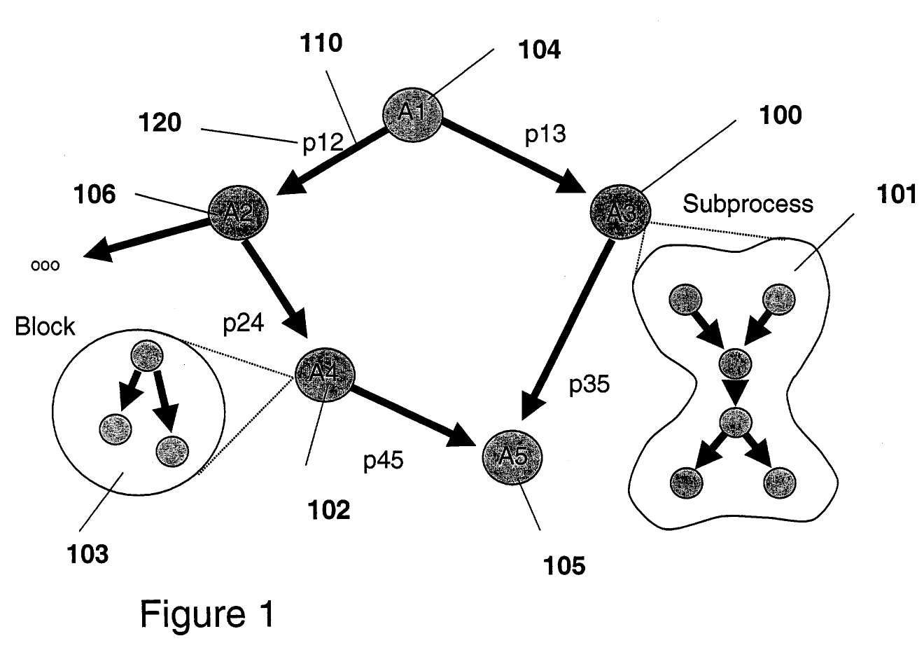

As an example of such a process model, FIG. 1 shows schematically the structure of such a process graph. Activities (A1 up to A5) are represented as named circles; the name typically describes the purpose of the activity. Activities come in various flavors to address the different tasks that may need to be performed. They may have different activity implementations to meet these diverse needs. Program activities are performed by an assigned program, process activities such as instance 100 are performed by another process 101, and blocks such as block 102 implement a macro 103 with a built-in do-until loop. Control connectors p12, p13, p24, p35, p45 are represented as arrows; the head of the arrow describes the direction in which the flow of control is moving through the process. The activity where the control connector starts is called the source activity; the activity where it ends is called the target activity. More than one control connector leaving an activity indicates potentially parallel work.

In general the activities, for example 104, 100, 106, 102, 105, describe the tasks to be performed and the control connectors, for example 110, describe the potential sequence in which the activities are to be carried out. Control connectors are associated with transition conditions. For example, control connector 120 is followed only if the transition condition (arbitrary complex Boolean predicates) evaluates to TRUE.

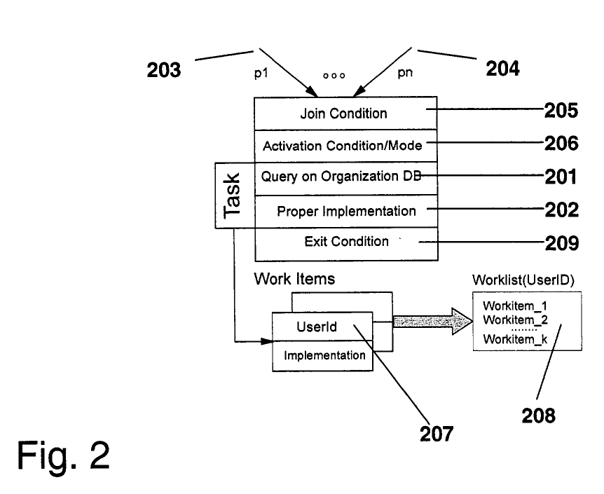

Activities describe the actual work that needs to be performed. FIG. 2 shows the inner details of an activity and indicates what is being done in the individual parts of an activity.

FIG. 2 visualizes a set of incoming control connectors 203 to 204 entering a certain activity. Conditions 205 and 206 specify when the activity is to be carried out, how the activity (and thus the implementation) is carried out, and how often the activity is invoked. The step of evaluating a “join condition” 205 is a means for specifying when an activity can be started depending on a logical predicate influenced by various parameters related to the incoming control connectors. The step of evaluating an “activation condition” 206 allows specification when the activity actually should be activated. It is a boolean expression. When it evaluates to TRUE, staff resolution takes place and work items are generated. Typical usages for activation conditions are for example to make sure that the activity is not started before 6 PM to avoid a possible heavy impact on more critical work. The “activation mode” defines whether the activity should be started manually or automatically.

The steps “query on organization database” 201 and “proper implementation” 202, representing the execution of the actual implementation of the activity, form the core of the activity.

The query against the organization database specifies in organizational terms who should carry out the activity. Since people in the organization are typically called staff, this query against the organizational database is also called a “staff query”. When the activity is ready for processing, this query is carried out and returns a set of users 207 that are assigned to the activity by means of “work items” 208. The process of finding the appropriate people is called “staff resolution”.

The step 209 of evaluating an “exit condition” is used to control when an activity really has completed. The exit condition is a boolean expression that can reference fields in the output container plus a special return code field. The return code field can be used by the activity implementation to set an appropriate return code. This return code would indicate whether the activity implementation has executed successfully or whether it needs further processing. When the exit condition evaluates to TRUE, navigation continues. When it evaluates to FALSE, the work item is put back onto the user's work list so that it can be started again.

The proper implementation (being executed within step 202) specifies what is used to actually carry out the activity and how it is to be carried out. The implementation could be a program that is executed or another process that is invoked. Definition of these executables is typically performed separately. There are several reasons for defining these programs.

There should be a clear separation between the conceptual construct of an activity and the actual implementation associated with the activity. This separation allows the modeler to first focus on the business process with its activities and then on the actual implementation of the individual activity.

The actual implementation is generally different for each of the different operating systems. When defining the activity, it is unknown on which operating system the activity will be executing and thus definitions may not be provided for each of the different operating systems on which the program will eventually run on.

It should be possible to change the implementation without impact on the activity in the business process. Thus, the workflow management system should resolve the actual program to be invoked when actually running the activity.

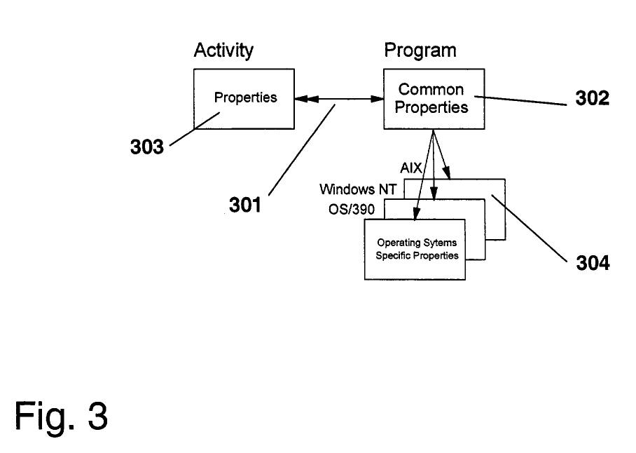

FIG. 3 illustrates the relationship between an activity (as a concept) and program (as its implementation). The double arrow on the relationship 301 indicates that a particular implementing program 302 can be the activity implementation of many activities 303. Each program is associated with a set of operating-system-specific definitions 302. When the activity is carried out, the WFMS locates the associated program 304 and then, depending on the operating system on which it needs to be carried out, selects the appropriate definition.

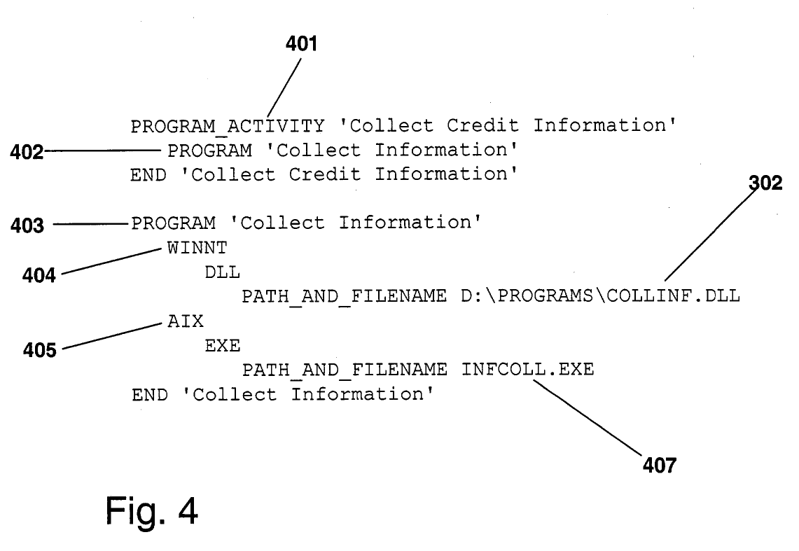

FIG. 4 shows a Flow Definition Language (FDL) fragment that illustrates how programs are defined and how the relationship between an activity and its associated implementation (activity implementation) is expressed. FDL is the flow definition language of MQSeries Workflow. It used for illustration only; any other language, textual or graphical, with comparable capabilities can be used instead.

The PROGRAM_ACTIVITY keyword 401 is used to define an activity that is implemented via a program. A similar keyword, PROCESS_ACTIVITY, is used to define activities that are implemented as processes. The PROGRAM keyword 402 with the activity definition associates the activity to a particular program. This program is defined by a PROGRAM section 403 that has appropriate definitions for Windows NT 404 and AIX 405. When the activity is carried out on Windows NT, the dynamic link library COLLINF.DLL 406 in the directory D:\PROGRAMS is invoked. When the activity is carried out on AIX, the executable INFCOLL.EXE 407 is executed.

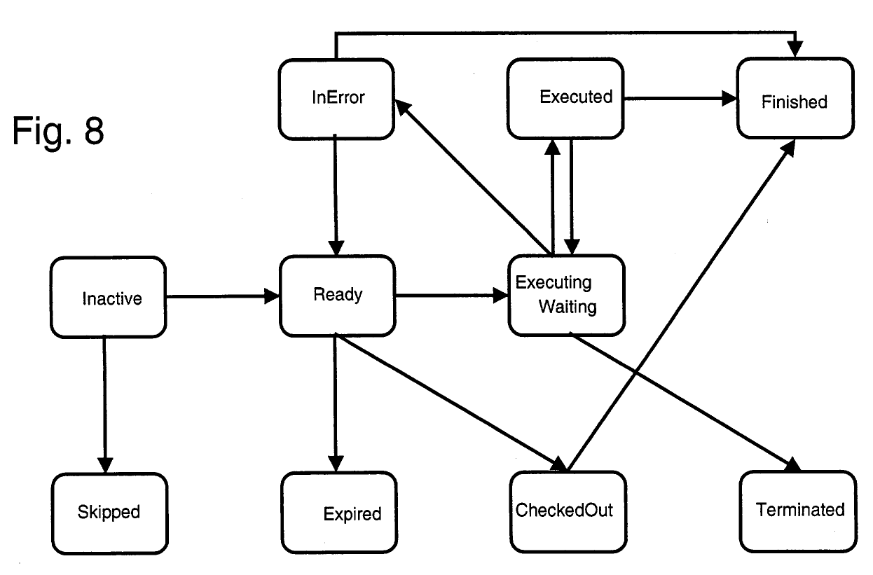

An activity instance occupies various states when it is carried out by the Workflow-Management-System. FIG. 8 illustrates some of those states. It should be noted that this is a simplified description provided for illustration purpose only. Workflow-Management-Systems typically differentiate between many more states.

An activity instance is a particular execution history of an activity within a process instance. It is uniquely identified via an object identifier. This object identifier is determined when the process instance is created. The object identifier is never reused.

At any time an activity instance has a state. A query via the activity instance identifier or indirectly via the process instance returns the current state.

Transition from one activity state to the next is performed as the result of a command on the activity instance, a command on the process instance, navigation through the process graph, or an error condition associated with the execution of the activity implementation.

FIG. 8 shows some of the states an activity can have in combination with the corresponding states transitions. These states are managed independently of the process states. This means that it is impossible to deduce the state of process instances from these states. Some of the relevant states of an activity instance are discussed next.

Inactive State: When a process instance is created, each activity is in this state. An activity is also inactivated, when it is part of a block activity, and the block activity is restarted due to a failing exit condition. All non-start activities are also put into this state, if the process is restarted.

Ready State: The activity is ready for execution. Applies to program activities, process activities, information activities, and the pattern activity associated with a bundle activity. The state is the result of one of the following actions:

a) Staff resolution has taken place, work items have been created, but no user has yet worked on the work item. This applies only to activities defined as MANUAL. Automatic activities are immediately executed if a user can be found, otherwise they are treated as manual activities.

b) The exit condition has failed and the associated work item has been put again onto the appropriate work list. The user has not yet worked on the work item again. This applies only to automatic activities.

c) The associated work item was force restarted by the user and the user has not yet worked again on the work item.

Executing/Waiting State: The associated activity implementation has started. For program activities, the associated program has been scheduled for execution. For process activities, the execution of an appropriate sub-process has been initiated. For block activities this state is occupied when the control flow has entered the block activity.

InError State: Program activities and process activities in this state indicate one of a multitude of error situations.

CheckedOut State: The activity was checked out to a particular user.

Executed State: The execution has ended for an activity. The activity will leave the state either through a finish request or a restart request.

Finished State: An activity is in this state after it has completed and exited correctly.

Terminated State: The activity has terminated.

Skipped State: The activity was skipped as a result of dead path elimination.

Expired State: An activity occupies this state if a time threshold has been exceeded without completing a certain activity.

The specification mentions a number of problem situations, including: an abnormal termination of an individual activity implementation; situations wherein the WFMS changes an activity from the running-state into an InError state due to a specific time-out value being exceeded; an abnormal termination of the WFMS itself; an abnormal termination of an infrastructure component underlying the WFMS; and in general activities for which the WFMS is in doubt about the processing status.

All of these problems can be solved very elegantly through the common concept of check activity implementations. The fundamental approach according to this solution is to associate each activity both with its regular activity implementation (to carry out the desired work) and with a further implementation, identified as a check activity implementation. Thus, an activity and its associated check activity implementation establish a duality relationship.

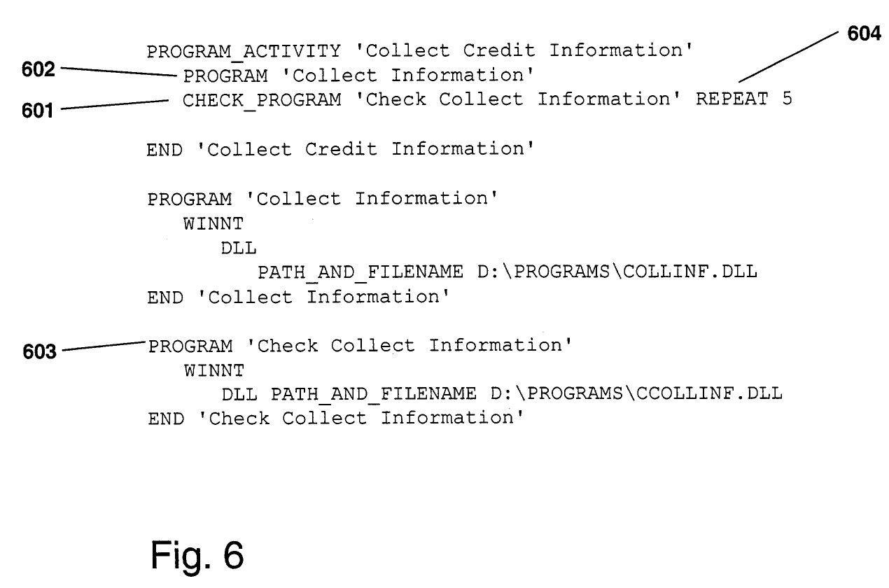

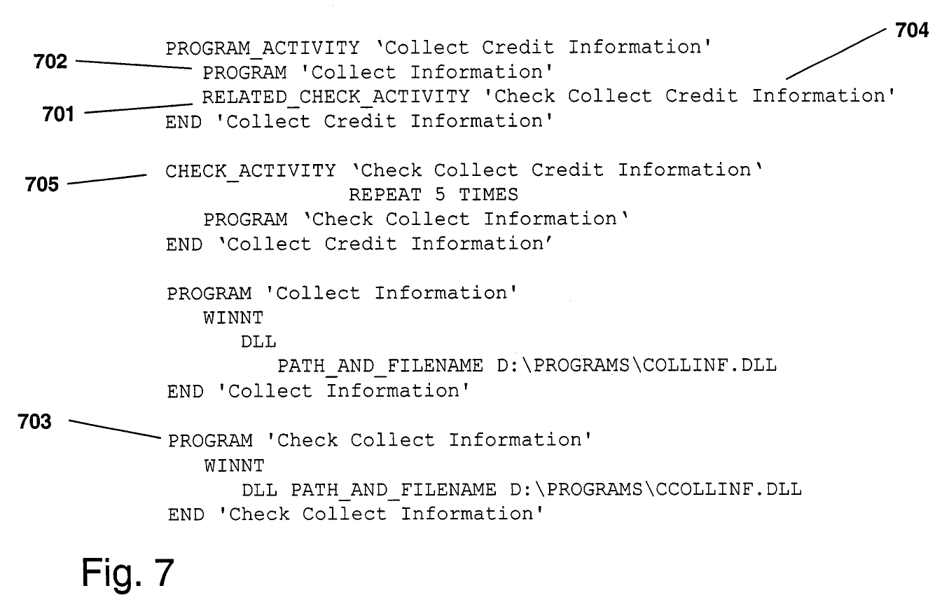

This association may take place in two different manners. An activity may be associated directly with a check activity implementation. This approach is discussed below with reference to FIG. 6. In a further approach, an activity may be associated with a check activity indirectly by associating an activity with a check activity and then associating the check activity with a check activity implementation. This approach is discussed below with reference to FIG. 7.

An activity may be associated with one or more check activity implementations; for instance, implementations for different operating systems. The purpose of the check activity implementation is to enable the WFMS to dynamically determine at any time the correct processing status of the corresponding regular activity implementation. As the dedicated check activity is specifically tailored to its associated activity it is able to analyze all the internals of the activity and thus it is capable of precisely determining the processing status of the activity. Based on this technology it is possible for instance to determine whether the regular activity implementation has been carried out or not, whether the regular activity implementation has been processed normally or has been successful only partially or even whether the regular activity is still running in a regular processing status (though possibly delayed somewhat even if predefined time-out values have been exceeded). Whenever the WFMS is in doubt on the processing status of one of its activities, it is necessary only for the WFMS locate and launch the associated check activity in order to dynamically determine the detailed processing status of the corresponding activity.

The check activity is even able to construct and to return the output container of the activity in exactly that form and with exactly that contents that would have been made available if the activity had been executed without any type of irregularity. This approach could even be applied directly to other approaches for passing data to and returning data from a certain activity.

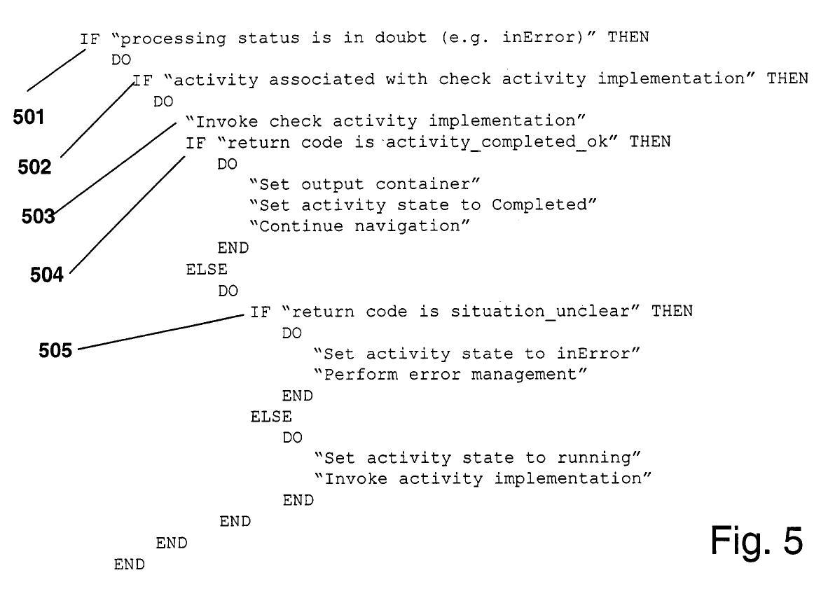

FIG. 5 shows, in pseudo-code, the actions that the WFMS executes when it is in doubt about the processing status of an activity instance.

Beginning with step 501, a check is made to determine whether the processing status for the activity instance of a certain activity is in doubt. Various types of situations may be considered as in doubt situations. Typical in doubt situations were listed earlier in this description. When a WFMS is being restarted following a crash caused by a direct failure of the WFMS or a failure of an underlying infrastructure component, such as the operation system, WFMS cannot rely any longer on the processing status of partially completed activity instances.

In this situation, the outcome of the activity implementation is unclear. The WFMS would thus perform the proposed methodology for all partially completed activity instances, treating them as in doubt. For the example of a restart situation, the WFMS locates all activity instances that are either in a running state or in an inError state.

Within step 502, the WFMS checks whether a check activity implementation has been defined and associated with the regular activity.

If this is the case, then within step 503 the check activity implementation is launched; that is, executed to determine the processing status of the corresponding activity.

If the check activity implementation determines within step 504 that the regular activity implementation was completed successfully:

a) the check activity constructs and returns the output container of the regular activity; and

b) the WFMS uses the returned output container to update the output container of the activity instance, sets the activity to a completed status, and continues navigation within the process instance.

If the check activity implementation determines within step 505 that the regular activity implementation has been partially processed or has been left in an unclear situation, the WFMS puts the activity instance in the InError state and performs appropriate error handling. The check activity implementation may even be able to “undo” all operations performed by the associated erroneous activity and thus return the activity to a pre-error state.

If the check activity implementation determines within step 506 that the regular activity implementation has not been processed at all, the workflow management system puts the activity instance into running state and invokes the regular activity implementation.

As already mentioned above, this methodology is not limited to WFMS restart situations. This method can also be applied if the WFMS discovers that an activity instance failed or an activity instance has been put into an inError state only because a specified time-out value is exceeded.

In a further embodiment of the current invention, an additional threshold value may be specified, defining how often the check activity implementation may be invoked.

In yet another embodiment of the current invention, the association between an activity and its associated check activity may be defined by new definition constructs directly within the processing model. Then all definitions relating to a certain process model are located at that same place. The processing time for determining an associated check activity can be greatly reduced by this approach. FIG. 6 illustrates this new definition construct within the example process model of FIG. 4. The Flow Definition Language of MQSeries Workflow is used for purposes of illustration.

Referring to FIG. 6, the new keyword CHECK_PROGRAM 601 is used to define the check activity associated with the regular activity 602. Further details for individual check activity implementations for the various operating systems are defined in section 603.

A REPEAT keyword 604 is used to specify how often the check activity implementation may be invoked, avoiding the possibility that the check activity could be repeated indefinitely.

FIG. 7 reflects an alternative implementation for the association of activities and corresponding check activities based on the same example as FIG. 6. Similar to FIG. 6, the keyword CHECK_PROGRAM 701 is used to define the check activity associated with the regular activity 702. In contrast to the implementation of FIG. 6, a dedicated definition section 705 allows further definition of the properties of the check activity. For instance, the REPEAT keyword 604 known already from FIG. 6 is used to specify how often the check activity implementation may be invoked.

Further details for individual check activity implementations for the various operating systems are defined in the new PROGRAM section 703.

The above mentioned duality relationship between an activity and its corresponding check activity becomes apparent from this figure.

1. A computer-implemented method for automatically supervising activity instances within a WorkFlow Management System (WFMS), said WFMS administering at least one process instance comprising an activity instance, said method comprising the steps of:
a) determining whether the processing status of the activity instance is in doubt;
b) responding to a determination indicates the status is in doubt, determining whether a dedicated check-activity implementation is associated with the activity, said check-activity implementation being capable of analyzing the processing status of the associated activity; and
c) when a dedicated check-activity implementation is determined to be associated with the activity, launching an instance of the dedicated check-activity implementation to determine the processing status of the activity instance.

2. A computer-implemented method according to claim 1 wherein each dedicated check-activity is specifically tailored to its associated activity for determining the processing status.

3. A computer-implemented method according to claim 2 where a processing status is defined as being in doubt when WFMS is being restarted following a crash of WFMS or an underlying infrastructure component or when an activity instance exceeds a predefined time-out value without termination of the activity.

4. A computer-implemented method according to claim 2 where, when a dedicated check-activity implementation is determined to be associated with the activity, further determining whether a limit exists for the number of times the check-activity implementation can be executed and, if so, proceeding with execution of the check-activity implementation only if that limit has not been reached.

5. A computer-implemented method according to claim 3 including the added steps of responding to a dedicated check-activity determination that the activity instance was completed by:
a) constructing an output container of the activity instance within the WFMS;
b) setting the activity instance to a completed state; and
c) causing the WFMS to continue navigation within the process instance.

6. A computer-implemented method according to claim 3 including the added steps of responding to a dedicated check-activity determination that the activity instance has failed by:
a) setting the activity instance to an in-error state; and
b) causing the WFMS to perform error processing for the activity instance.

7. A computer-implemented method according to claim 3 including the added steps of responding to a dedicated check-activity determination that the activity instance has neither completed successfully, failed, or entered a running state by:
a) setting the activity instance to a running state; and
b) launching execution of the activity instance.

8. A WorkFlow Management System for automatically supervising activity, said System administering at least one process instance comprising an activity instance and comprising:
a) logic for determining whether the processing status of the activity instance is in doubt;
b) logic responsive to a determination that the status is in doubt for determining whether a dedicated check-activity implementation is associated with the activity, said check-activity implementation being capable of analyzing the processing status of the associated activity; and
c) logic responsive to a determination that a dedicated check-activity implementation is associated with the activity for launching an instance of the dedicated check-activity implementation to determine the processing status of the activity instance.

9. A data processing program for execution in a data processing system comprising software code for performing a method of automatically supervising activity instances within a WorkFlow Management System (WFMS), said WFMS administering at least one process instance comprising an activity instance, said method comprising the steps of:
a) determining whether the processing status of the activity instance is in doubt;
b) when the determination indicates the status is in doubt, determining whether a dedicated check-activity implementation is associated with the activity, said check-activity implementation being capable of analyzing the processing status of the associated activity; and
c) when a dedicated check-activity implementation is determined to be associated with the activity, launching an instance of the dedicated check-activity implementation to determine the processing status of the activity instance.
